(19) United States
(12) Patent Application Publication
(10) Pub. No.: US 2026/0354427 A1
(43) Pub. Date: Nov. 12, 2026

(54) SUGAR-OFF NOODLES, MASKING AGENT, AND MASKING METHOD

(71) Applicant: EZAKI GLICO CO., LTD., Osaka (JP)

(72) Inventors: Nanako TOKUMITSU, Osaka (JP); Nobuo YASUDA, Osaka (JP); Midori MATAYOSHI, Osaka (JP)

(73) Assignee: EZAKI GLICO CO., LTD., Osaka (JP)

(21) Appl. No.: 19/135,248

(22) PCT Filed: Dec. 5, 2023
(86) PCT No.: PCT/JP2023/043458

§ 371 Date: Jun. 16, 2025

(30) Foreign Application Priority Data
Dec. 5, 2022 (JP) 2022-194198

(51) Int. Cl. A23L 7/113; A23J 3/18; A23L 27/00

(52) U.S. Cl. CPC A23L 7/113; A23J 3/18; A23L 27/84

(57) ABSTRACT

Noodles containing wheat flour and further containing wheat protein,
the proportion of the wheat protein in the total amount of powdered raw materials contained in the noodles being 10 mass % or more,
the noodles having an available carbohydrate content reduced by 25 mass % or more compared with noodles containing only wheat flour as a powdered raw material, and
the noodles containing a dried-bonito powder in an amount of 0.2 to 10 mass % based on the total amounts of the powdered raw materials.

### TECHNICAL FIELD

The present invention relates to low available carbohydrate noodles, a masking agent, and a masking method.

### BACKGROUND ART

Low available carbohydrate foods are attracting attention as diet meals, meals for diabetics, and the like, and in particular, reducing the available carbohydrate content of staple foods, such as rice, noodles, and bread, is being investigated in various places. The same is true for noodles obtained using wheat flour. However, when the amount of wheat flour in the raw materials for noodles is reduced to decrease the available carbohydrate content, desirable textures, such as springy texture, are reduced, and the production suitability is also reduced; thus, wheat protein is used to compensate for this. Incorporating wheat protein can improve desirable textures, such as springy texture, and production suitability, but has a problem in that an unpleasant odor derived from wheat protein (gluten odor) is produced.

### CITATION LIST

### Patent Literature

PTL 1: JP2020-162469A
PTL 2: JP2011-120549A
PTL 3: JPS60-126043A

### SUMMARY OF INVENTION

### Technical Problem

An object of the present invention is to reduce the unpleasant odor derived from wheat protein in low available carbohydrate noodles containing wheat protein.

### Solution to Problem

Under such circumstances, the present inventors conducted extensive research and found that by incorporating a dashi (soup stock) powder into low available carbohydrate noodles containing wheat protein, the unpleasant odor derived from wheat protein is less noticeable. The present invention has been accomplished based on this novel finding. Thus, the present invention provides the following items.

Item 1. Noodles comprising wheat flour and further comprising wheat protein,
the proportion of the wheat protein in the total amount of powdered raw materials contained in the noodles being 10 mass % or more,
the noodles having an available carbohydrate content reduced by 25 mass % or more compared with noodles containing only wheat flour as a powdered raw material, and
the noodles comprising a dashi powder in an amount of 0.2 to 10 mass % based on the total amount of the powdered raw materials.

Item 2. Noodles comprising wheat flour and further comprising wheat protein,
the proportion of the wheat protein in the total amount of powdered raw materials contained in the noodles being 10 mass % or more,
the noodles having an available carbohydrate content reduced by 25 mass % or more compared with noodles containing only wheat flour as a powdered raw material, and
the noodles comprising a dried-bonito powder in an amount of 0.2 to 10 mass % based on the total amount of the powdered raw materials.

Item 3. The noodles according to Item 1 or 2, which have an available carbohydrate content reduced by 50 mass % or more compared with noodles containing only wheat flour as a powdered raw material.

Item 4. The noodles according to any one of Items 1 to 3, wherein the proportion of the wheat protein in the total amount of the powdered raw materials constituting the noodles is 15 mass % or more.

Item 5. A masking agent for an unpleasant odor derived from wheat protein caused by low available carbohydrate noodles, the masking agent comprising a dashi powder, the low available carbohydrate noodles comprising wheat flour and wheat protein and having a reduced available carbohydrate content compared with noodles containing only wheat flour as a powdered raw material.

Item 6. A masking agent for an unpleasant odor derived from wheat protein caused by low available carbohydrate noodles, the masking agent comprising a dried-bonito powder, the low available carbohydrate noodles comprising wheat flour and wheat protein and having a reduced available carbohydrate content compared with noodles containing only wheat flour as a powdered raw material.

Item 7. The noodles according to any one of Items 1 to 4 or the masking agent according to Item 5 or 6, wherein the noodles are pasta.

Item 8. A method for masking an unpleasant odor derived from wheat protein caused by low available carbohydrate noodles, the method comprising adding a dashi powder to powdered raw materials constituting the low available carbohydrate noodles, the low available carbohydrate noodles comprising wheat flour and wheat protein and having a reduced available carbohydrate content compared with noodles containing only wheat flour as a powdered raw material.

Item 9. A method for masking an unpleasant odor derived from wheat protein caused by low available carbohydrate noodles, the method comprising adding a dried-bonito powder to powdered raw materials constituting the low available carbohydrate noodles, the low available carbohydrate noodles comprising wheat flour and wheat protein and having a reduced available carbohydrate content compared with noodles containing only wheat flour as a powdered raw material.

Item 10. The method according to Item 8 or 9, wherein the low available carbohydrate noodles have an available carbohydrate content reduced by 25 mass % or more compared with noodles containing only wheat flour as a powdered raw material.

Item 11. The method according to any one of Items 8 to 10, wherein the noodles are pasta.

### Advantageous Effects of Invention

The present invention provides low available carbohydrate noodles containing wheat protein in which the unpleasant odor derived from wheat protein is reduced.

### DESCRIPTION OF EMBODIMENTS

### Low Available Carbohydrate Noodles

In one embodiment, the present invention provides noodles containing wheat flour and further containing wheat protein,
the proportion of the wheat protein in the total amount of powdered raw materials contained in the noodles being 10 mass % or more,
the noodles having an available carbohydrate content reduced by 25 mass % or more compared with noodles containing only wheat flour as a powdered raw material, and
the noodles containing a dried-bonito powder in an amount of 0.2 to 10 mass % based on the total amount of the powdered raw materials.

In one embodiment, the present invention provides noodles containing wheat flour and further containing wheat protein,
the proportion of the wheat protein in the total amount of powdered raw materials contained in the noodles being 10 mass % or more,
the noodles having an available carbohydrate content reduced by 25 mass % or more compared with noodles containing only wheat flour as a powdered raw material, and
the noodles containing a dashi powder in an amount of 0.2 to 10 mass % based on the total amount of the powdered raw materials.

In the present invention, “low available carbohydrate noodles” means noodles with a reduced available carbohydrate content obtained by incorporating a raw material with a low available carbohydrate content in place of some of the wheat flour, which is the main raw material. More specific examples include noodles having an available carbohydrate content reduced by 25 mass % or more compared with noodles containing only wheat flour as a powdered raw material, noodles having an available carbohydrate content reduced by 50 mass % or more compared with noodles containing only wheat flour as a powdered raw material, and the like. In the present invention, the upper limit of the amount of available carbohydrate reduction is not limited, and can be, for example, selected from 99.9 mass % or less, 95% mass % or less, 90% mass % or less, 85 mass % or less, 80 mass % or less, 75 mass % or less, 70 mass % or less, 65 mass % or less, 60 mass % or less, 55 mass % or less, 50 mass % or less, 45 mass % or less, 40 mass % or less, 35 mass % or less, 30 mass % or less, or the like, compared with noodles containing only wheat flour as a powdered raw material. “Noodles having an available carbohydrate content reduced by 25 mass % or more compared with noodles containing only wheat flour as a powdered raw material” are, for example, appropriately selected from noodles having an available carbohydrate content reduced by 25 mass % or more and 40 mass % or less compared with noodles containing only wheat flour as a powdered raw material, noodles having an available carbohydrate content reduced by 25 mass % or more and 35 mass % or less compared with noodles containing only wheat flour as a powdered raw material, noodles having an available carbohydrate content reduced by 25 mass % or more and 30 mass % or less compared with noodles containing only wheat flour as a powdered raw material, noodles having an available carbohydrate content reduced by 25 mass % or more compared with noodles containing only wheat flour as a powdered raw material, and the like. “Noodles having an available carbohydrate content reduced by 50 mass % or more compared with noodles containing only wheat flour as a powdered raw material” are appropriately selected from noodles having an available carbohydrate content reduced by 50 mass % or more and 60 mass % or less compared with noodles containing only wheat flour as a powdered raw material, noodles having an available carbohydrate content reduced by 50 mass % or more and 55 mass % or less compared with noodles containing only wheat flour as a powdered raw material, and the like.

In the present invention, “noodles” means a food obtained by a method including kneading powdered raw materials containing wheat flour to which water is added as appropriate, and rolling out the resulting dough thinly or into narrow strips. Among fresh noodles, noodles in a cylindrical or band-like shape are indicated as noodles. The shape of the noodles is not particularly limited, and examples include, but are not limited to, a cylindrical shape, a band-like shape, a tube-like shape, a plate-like shape, a disk-like shape, a shell-like shape, a ribbon-like shape, a butterfly-like shape, a spiral-like shape, a granular shape, and the like. The type of noodles is not particularly limited as long as it contains wheat flour. Examples include pasta, udon (thick noodles made from wheat flour), somen (thin Japanese noodles), hiyamugi (Japanese noodles served cold), Chinese noodles (e.g., Chinese noodles and wrappers for gyoza (Chinese-style dumplings), shumai (steamed Chinese dumplings), wonton, etc.), with pasta being preferable. Examples of pasta include long pasta, such as spaghetti, capellini, linguine, fettuccine, and tagliatelle; short pasta, such as macaroni, penne, farfalle, rigatoni, fusilli (spirale, curls), conchiglie (shells), gnocchi, and couscous; plate-shaped pasta, such as lasagna and ravioli; and the like. The noodles of the present invention may be fresh noodles or dried noodles. In the present invention, noodles with a water content of more than 20 wt % are referred to as “fresh noodles,” and noodles with a water content of 20 wt % or less are referred to as “dried noodles.” Dried noodles can be obtained, for example, by drying fresh noodles until a certain water content is reached.

As the wheat flour, a wide range of wheat flour that can be used as a raw material for noodles can be used, and examples include bread flour, cake flour, and the like. Examples of wheat that can be used as a raw material for the wheat flour include common wheat, durum wheat, and the like, and it is preferable to use durum wheat flour (e.g., durum semolina) made from durum wheat. These kinds of wheat flour may be used singly or in a combination of two or more. The amount of the wheat flour in the total amount of the powdered raw materials is not limited and can be appropriately set, for example, depending on the percentage by which the available carbohydrate content is to be reduced. For example, the amount of the wheat flour in the total amount of the powdered raw materials is 0.01 mass % or more, 0.1 mass % or more, 1 mass % or more, 5 mass % or more, 10 mass % or more, 20 mass % or more, 30 mass % or more, 40 mass % or more, 50 mass % or more, 60 mass % or more, 70 mass % or more, or the like. The upper limit of the amount of the wheat flour in the total amount of the powdered raw materials is also not limited and can be appropriately set, for example, depending on the percentage by which the available carbohydrate content is to be reduced. For example, the upper limit of the amount of the wheat flour in the total amount of the powdered raw materials is 75 mass % or less, 70 mass % or less, 50 mass % or less, 40 mass % or less, or the like. In typical pasta, wheat flour accounts for 100 mass % of the powdered raw materials.

In the present invention, the dashi is not particularly limited as long as it adds an aroma that enhances deliciousness and imparts umami that does not overpower other flavors. A wide range of dashi that can be generally used as dashi can be used. Examples of dashi include seafood-based dashi (preferably fish-based dashi), such as dashi made from dried bonito, dashi made from small dried sardines, dashi made from dried mackerel, flying-fish dashi (dashi made from dried flying fish), dashi made from fish bones, and dashi made from freshwater clams; plant-based dashi, such as dashi made from kelp, dashi made from shiitake mushrooms, and dashi made from vegetables; and meat-based dashi, such as dashi made from chicken (including dashi made from chicken bones), dashi made from beef (including dashi made from beef bones), and dashi made from pork (including dashi made from pork bones), with seafood-based dashi being preferable. In the present invention, these kinds of dashi may be used singly or in a combination of two or more (for example, a combination dashi of dried bonito and kelp). Examples of raw materials for the dashi include seafood-based raw materials (preferably fish-based raw materials), such as dried bonito, small dried sardines, dried mackerel, flying fish (dried flying fish), fish bones, kelp, small dried sardines, and freshwater clams; plant-based raw materials, such as kelp, shiitake mushrooms, and vegetables; meat-based raw materials, such as chicken (including chicken and chicken bones), beef (including beef and beef bones), and pork dashi (including pork and pork bones); and the like. These raw materials are preferably dried. These raw materials may be in the form of powder or the like. Among these raw materials, seafood-based raw materials (preferably fish-based raw materials) are preferable, and dried bonito is particularly preferable. These raw materials may be used singly or in a combination of two or more. Further, one or more kinds of dashi described above may be used in combination with one or more of the raw materials for dashi. In the present invention, the term “dashi” includes not only an extract (dashi liquid) extracted from a raw material described above, but also the extract that is concentrated, the extract that is a powdered, the extract that is granulated, and the like. In the present invention, the term “dashi powder” includes dashi in powder form, granular form, and the like (those obtained by, for example, powdering or granulating a dashi liquid), powdered raw materials for dashi, and the like. In the present invention, powdered raw materials for dashi are preferable, and it is particularly preferred that the dashi powder contains a dried-bonito powder.

In an embodiment using a dried-bonito powder as the dashi powder, examples of dried bonito that can be used as raw materials for the dried-bonito powder include arabushi, karebushi, honkarebushi, and the like. “Arabushi” typically refers to dried bonito obtained by removing the head and internal organs of bonito, boiling the bonito, removing the bones, and smoke-drying the bonito. “Karebushi” typically refers to dried bonito obtained by subjecting arabushi to mold application and drying at least twice. “Honkarebushi” typically refers to dried bonito obtained by further repeating the mold application and drying process described for karebushi above for further maturing. “Mold application” typically refers to attaching mold to arabushi or karebushi and then leaving the mold-attached arabushi or karebushi (at a predetermined temperature) to culture and grow the mold. The drying step is typically done by drying in the sun.

In an embodiment using a dried-bonito powder as the dashi powder, the amount of the dried-bonito powder in the total amount of the powdered raw materials is preferably 10 mass % or less, more preferably 1 mass % or less, and even more preferably 0.8 mass % or less. The amount of the dried-bonito powder in the total amount of the powdered raw materials is preferably 0.2 mass % or more. From the viewpoint of making an unpleasant odor derived from wheat protein (gluten odor) less noticeable and not allowing the flavor of dried bonito itself to be perceived, the amount of the dried-bonito powder in the total amount of the powdered raw materials is preferably within the above range. In an embodiment using powders other than a dried-bonito powder as the dashi powder, they can be contained in the same proportion as described above. The amount of the dashi powder (which may or may not contain a dried-bonito powder) in the total amount of the powdered raw materials is, for example, preferably 10 mass % or less, more preferably 1 mass % or less, and even more preferably 0.8 mass % or less. The amount of the dashi powder in the total amount of the powdered raw materials is, for example, preferably 0.2 mass % or more.

In the present invention, “0.2 mass %” includes a numerical value that is rounded off to one decimal place to 0.2 mass %. Thus, 0.18 mass % and the like are also included in “0.2 mass % or more.” Similarly, in the present invention, “10 mass %” includes a numerical value that is rounded off to the nearest whole number to 10 mass % (e.g., 10.2 mass % and the like). Similarly, with regard to other numerical values, unless otherwise specified in the present specification, the numerical ranges described in the specification also include numerical values in which the digit one place after a numerical value stated in the specification (for example, if the specification states “1.0,” the value in the second decimal place) is rounded off to become the numerical value stated (in that case, 1.02 is included in “1.0”).

The noodles of the present invention further contain wheat protein. “Wheat protein” refers to vegetable protein extracted from wheat, and is sometimes called “wheat gluten” or the like. Wheat protein can be obtained, for example, by adding water to wheat flour, kneading the mixture, and washing the resulting dough with water. Incorporating wheat protein can compensate for the textures (springy texture, bouncy texture, chewy texture, etc. of noodles) reduced by decreasing the amount of wheat flour, and production suitability. The amount of the wheat protein in the total amount of the powdered raw materials is, for example, preferably 5 mass % or more, more preferably 7 mass % or more, and even more preferably 10 mass % or more. The upper limit of the amount of the wheat protein in the total amount of the powdered raw materials is not limited, and is, for example, preferably 30 mass % or less, more preferably 20 mass % or less, and even more preferably 18 mass % or less. In the present invention, the term “wheat protein” is intended to mean wheat protein other than the protein contained in wheat flour, which is another component of the noodles of the present invention. Thus, the amount of the wheat protein in the total amount of the powdered raw materials means the proportion of wheat protein other than the protein contained in wheat flour based on the total amount of the powdered raw materials. From the viewpoint of improving production suitability and imparting a good texture, the amount of the wheat protein in the total amount of the powdered raw materials is preferably within the above range. In an embodiment using a dried-bonito powder as the dashi powder, the ratio of the wheat protein to the dried-bonito powder is not limited, and, for example, the amount of the dried-bonito powder is preferably 0.5 to 100 parts by mass, more preferably 0.8 to 15 parts by mass, and even more preferably 1.0 to 10 parts by mass, per 100 parts by mass of the wheat protein. When powders other than a dried-bonito powder are used as the dashi powder, they can be contained in the same proportion as described above. The ratio of the wheat protein to the dashi powder (which may or may not contain a dried-bonito powder) is not limited, and, for example, the amount of the dashi powder is preferably 0.5 to 100 parts by mass, more preferably 0.8 to 15 parts by mass, and even more preferably 1.0 to 10 parts by mass, per 100 parts by mass of the wheat protein.

In order to reduce the available carbohydrate content, the noodles of the present invention preferably contain a raw material with a low available carbohydrate content in addition to the wheat protein. The raw material with a low available carbohydrate content is not particularly limited, and examples include modified starch, dietary fiber, konjac flour, soy flour, okara (soy pulp), soybean milk powder, and the like. Examples of raw materials with a low available carbohydrate content include those with an available carbohydrate content of 70 mass % or less, preferably 25 mass % or less, and more preferably 0 mass %. These raw materials with a low available carbohydrate content can be used singly or in a combination of two or more. When a raw material with a low available carbohydrate content is used, the amount of the raw material for use is not limited, and the raw material with a low available carbohydrate content (other than wheat protein) may be contained in an amount of, for example, 5 mass % or more, preferably 10 mass % or more, and even more preferably 25 mass % or more, based on the total amount of the powdered raw materials. When a raw material with a low available carbohydrate content is used, the upper limit of the amount of the raw material for use is also not limited, and the raw material with a low available carbohydrate content (other than wheat protein) may be contained in an amount of, for example, 89.8 mass % or less, preferably 50 mass % or less, and more preferably 25 mass % or less, based on the total amount of the powdered raw materials. From the viewpoint of reducing the available carbohydrate content of the noodles and maintaining a good texture, the amount of the raw material with a low available carbohydrate content in the total amount of the powdered raw materials is preferably within the above range.

The noodles of the present invention may further contain one or more additives, such as animal and vegetable proteins (animal and vegetable proteins other than wheat protein), such as egg white, milk protein, and soybean protein; dietary fiber, such as food-derived cellulose and hemicellulose; indigestible available carbohydrates, such as oligosaccharide, erythritol, reduced dextrin, and polydextrose; polysaccharide thickeners, such as xanthan gum, guar gum, carrageenan, curdlan, agar, konjac, gelatin, tamarind gum, alginic acid, and gellan gum; indigestible dextrin; emulsifiers (e.g., glycerin fatty acid ester, sorbitan fatty acid ester, sucrose fatty acid ester, lecithin, and enzyme-treated lecithin); organic acids (e.g., citric acid, lactic acid, acetic acid, malic acid, tartaric acid, and adipic acid); inorganic acids (e.g., phosphoric acid, carbonic acid, hydrochloric acid, and sulfuric acid); alkali metal (e.g., sodium or potassium) or alkaline earth metal (e.g., calcium or magnesium) salts; coloring agents; vegetable powders; and waxy barley flour. When an additive is used, the amount of the additive is not limited, and is, for example, 10 wt % or less, and preferably 5 wt % or less, of the total amount of the noodles on a dry-weight basis. When an additive is used, the lower limit of the amount of the additive is also not limited, and can be appropriately set within the range of, for example, 1 mass % or more, preferably 2 mass % or more, and more preferably 3 mass % or more, of the total amount of the noodles on a dry-weight basis.

The noodles of the present invention can be produced, for example, by blending wheat flour, wheat protein, a dashi powder (preferably a dried-bonito powder), optional raw material(s) described above, and water in appropriate amounts, mixing them with a mixer, such as a pin mixer or a vertical mixer, forming the mixture into a sheet, cutting the sheet, and in the case of dried noodles, further performing a drying step. Of course, the noodles of the present invention can be produced by mixing with a mixer in the same manner as described above and extruding with a pasta machine or the like, or forming by other ordinary methods.

In a typical embodiment, the noodles of the present invention have a springy texture while being low available carbohydrate noodles; further, in the noodles of the present invention, the unpleasant odor derived from wheat protein is less noticeable, and additionally, the flavor of the dashi powder (in particular, when a dried-bonito powder is used, the flavor of the dried-bonito powder itself) is almost imperceptible. Thus, the noodles of the present invention are useful because they can be used in dishes with various seasonings.

### Masking Agent

As described above, according to the present invention, an unpleasant odor derived from wheat protein can be masked by incorporating a dried-bonito powder into low available carbohydrate noodles containing wheat protein. Thus, in one embodiment, the present invention provides a masking agent for an unpleasant odor derived from wheat protein caused by low available carbohydrate noodles, the masking agent containing a dashi powder (preferably a dried-bonito powder), the low available carbohydrate noodles containing wheat flour and wheat protein and having a reduced available carbohydrate content compared with noodles containing only wheat flour as a powdered raw material. In the present invention, “masking” means that the addition of a masking agent component to a food makes the target unpleasant odor less noticeable compared with a food to which no masking agent component is added. Typically, masking in the present invention is intended to make an unpleasant odor derived from wheat protein less noticeable due to the combination of the flavor of a dashi powder (preferably a dried-bonito powder) and the unpleasant odor derived from wheat protein, rather than a chemical reaction between the dashi powder (such as a dried-bonito powder), which is an active ingredient, and the aromatic component that constitutes the unpleasant odor derived from wheat protein. In a typical embodiment, the masking agent of the present invention can mask an unpleasant odor derived from wheat protein, and further, the flavor of the dashi powder (preferably a dried-bonito powder) itself is almost imperceptible. Accordingly, the masking agent of the present invention is useful because it can be applied to various dishes.

In the present invention, the dashi powder (preferably a dried-bonito powder) itself may be used as the masking agent, or may be used as a masking agent composition further containing an additive commonly used in the field of foods (such as a coloring agent, a preservative, or an antioxidant). In an embodiment of a masking agent composition, the amount of the dashi powder (preferably a dried-bonito powder) is not limited, and can be appropriately set from the range of, for example, 50 mass % or more, 70 mass % or more, 80 mass % or more, 90 mass % or more, 95 mass % or more, or 99 mass % or more, based on the total amount of the masking agent composition taken as 100 mass %.

The present invention also provides a method for masking an unpleasant odor derived from wheat protein caused by low available carbohydrate noodles, the method including adding a dashi powder (preferably a dried-bonito powder) to raw materials for low available carbohydrate noodles, the low available carbohydrate noodles containing wheat flour and wheat protein and having a reduced available carbohydrate content compared with noodles containing only wheat flour as a powdered raw material. When to add the dashi powder (preferably a dried-bonito powder) to the raw materials for low available carbohydrate noodles is not limited. For example, the dashi powder (preferably a dried-bonito powder) may be added after all of the powdered raw materials except the dashi powder are mixed, or the dashi powder may be added when the powdered raw materials are sequentially mixed. The low available carbohydrate noodles, the raw materials for the noodles, the dashi powder (preferably a dried-bonito powder), the proportions of these used, the method for producing the noodles, etc. in the embodiments of the masking agent and the masking method are the same as those described in the “Low Available Carbohydrate Noodles” section.

The present invention is described below in more detail with reference to Examples and Comparative Examples. However, the present invention is not limited to these Examples. In the following, the amounts are expressed on a mass basis unless otherwise specified.

### EXAMPLES

### Example 1: Noodles with Available Carbohydrate Content Reduced by 25%

About 40 parts by mass of water was added to 100 parts by mass of the total amount of the powdered raw materials of the types and in the amounts shown in Table 1 below, followed by mixing. The resulting mixture was rolled and cut to obtain fresh noodles. Specifically, a pin mixer was used for mixing, and after mixing at high speed for 7 minutes and then at low speed for another 7 minutes, the mixture was rolled with a noodle-making roller and cut, thereby obtaining 2.5 mm-thick fresh noodles with an available carbohydrate content reduced by 25%. The obtained fresh noodles were dried overnight, boiled, and subjected to a sensory test. Powdered karebushi (dried bonito) was used as a dried-bonito powder. The raw materials used are as follows (the same applies to the following Example).

TABLE 1

| | Test | Test | Test | Test | Test |
|---|---|---|---|---|---|
| | Exam- | Exam- | Exam- | Exam- | Exam- |
| | ple 1-1 | ple 1-2 | ple 1-3 | ple 1-4 | ple 1-5 |
| Durum wheat | 65.750 | 65.750 | 65.750 | 65.750 | 65.750 |
| flour | | | | | |
| Modified starch | 15.000 | 15.000 | 15.000 | 15.000 | 15.000 |
| Wheat protein | 15.000 | 15.000 | 15.000 | 15.000 | 15.000 |
| Waxy barley | 4.250 | 4.250 | 4.250 | 4.250 | 4.250 |
| flour | | | | | |
| Dried-bonito | | 0.200 | 0.400 | 0.600 | 0.800 |
| powder | | | | | |
| Total | 100.0 | 100.2 | 100.4 | 100.6 | 100.8 |

The available carbohydrate content per 100 g of each raw material used above is as follows: durum wheat flour: about 70 g; modified starch: 0 g; wheat protein: about 6 g; waxy barley flour: about 65 g. The sensory test was performed by four expert panelists in sensory testing in the field of foods (the same applies to the following Example). The evaluation criteria are as follows.

### Intensity of Gluten Odor

0: No noticeable gluten odor and no noticeable flavor
1: Slightly noticeable
2: Mildly noticeable
3: Noticeable
4: Moderately strong
5: Very strong gluten odor (gluten odor of Test Example 1-1 or stronger)

### Intensity of Bonito Flavor

0: No noticeable bonito flavor (same level as in Test Example 1-1)
1: Slightly noticeable
2: Mildly noticeable
3: Noticeable
4: Moderately strong
5: Very strong bonito flavor
   Table 2 shows the results of the sensory test.

TABLE 2

| | | Evaluation |
|---|---|---|
| | | results |
| Test | Intensity of gluten odor | 5.0 |
| Exam- | (0 (no noticeable gluten odor) | |
| ple 1-1 | to 5 (very strong gluten odor)) | |
| | Intensity of bonito flavor | 0.0 |
| | (0 (no noticeable bonito flavor) | |
| | to 5 (very strong bonito flavor)) | |
| Test | Intensity of gluten odor | 3.5 |
| Exam- | (0 (no noticeable gluten odor) | |
| ple 1-2 | to 5 (very strong gluten odor)) | |
| | Intensity of bonito flavor | 0.3 |
| | (0 (no noticeable bonito flavor) | |
| | to 5 (very strong bonito flavor)) | |
| Test | Intensity of gluten odor | 0.5 |
| Exam- | (0 (no noticeable gluten odor) | |
| ple 1-3 | to 5 (very strong gluten odor)) | |
| | Intensity of bonito flavor | 1.0 |
| | (0 (no noticeable bonito flavor) | |
| | to 5 (very strong bonito flavor)) | |
| Test | Intensity of gluten odor | 0.0 |
| Exam- | (0 (no noticeable gluten odor) | |
| ple 1-4 | to 5 (very strong gluten odor) | |
| | Intensity of bonito flavor | 2.8 |
| | (0 (no noticeable bonito flavor) | |
| | to 5 (very strong bonito flavor)) | |
| Test | Intensity of gluten odor | 0.0 |
| Exam- | (0 (no noticeable gluten odor) | |
| ple 1-5 | to 5 (very strong gluten odor)) | |
| | Intensity of bonito flavor | 5.0 |
| | (0 (no noticeable bonito flavor) | |
| | to 5 (very strong bonito flavor)) | |

As shown in the above results, the gluten odor was suppressed by incorporating the dried-bonito powder into noodles with an available carbohydrate content reduced by 25%. In Test Example 1-2 to Test Example 1-3, the bonito flavor was not noticeable or was slightly noticeable. In Test Example 1-4, the bonito flavor was noticeable, but was not strong. In Test Example 1-5, the bonito flavor was noticeable.

### Example 2: Noodles with Available Carbohydrate Content Reduced by 50%

Fresh noodles with an available carbohydrate content reduced by 50% were obtained by the same process as in Example 1, using the materials in the amounts shown in Table 3 below. The obtained fresh noodles were dried overnight, boiled, and subjected to a sensory test.

TABLE 3

| | Test | Test | Test | Test | Test |
|---|---|---|---|---|---|
| | Exam- | Exam- | Exam- | Exam- | Exam- |
| | ple 2-1 | ple 2-2 | ple 2-3 | ple 2-4 | ple 2-5 |
| Durum wheat | 41.250 | 41.250 | 41.250 | 41.250 | 41.250 |
| flour | | | | | |
| Modified starch | 44.500 | 44.500 | 44.500 | 44.500 | 44.500 |
| Wheat protein | 10.000 | 10.000 | 10.000 | 10.000 | 10.000 |
| Waxy barley | 4.250 | 4.250 | 4.250 | 4.250 | 4.250 |
| flour | | | | | |
| Dried-bonito | | 0.200 | 0.400 | 0.600 | 0.800 |
| powder | | | | | |
| Total | 100.0 | 100.2 | 100.4 | 100.6 | 100.8 |

The available carbohydrate content per 100 g of each raw material used above is as follows: durum wheat flour: about 70 g; modified starch: about 0.3 g; wheat protein: about 15 g; waxy barley flour: about 65 g. The sensory test was performed by four panelists according to the following criteria. The following criteria are the same as those in Test Example 1. Table 4 shows the results.

### Intensity of Gluten Odor

0: No noticeable gluten odor and no noticeable flavor
1: Slightly noticeable
2: Mildly noticeable
3: Noticeable
4: Moderately strong
5: Very strong gluten odor

### Intensity of Bonito Flavor

0: No noticeable bonito flavor and no noticeable flavor
1: Slightly noticeable
2: Mildly noticeable
3: Noticeable
4: Moderately strong
5: Very strong bonito flavor

TABLE 4

| | | Evaluation |
|---|---|---|
| | | results |
| Test | Intensity of gluten odor | 3.0 |
| Exam- | (0 (no noticeable gluten odor) | |
| ple 2-1 | to 5 (very strong gluten odor)) | |
| | Intensity of bonito flavor | 0.0 |
| | (0 (no noticeable bonito flavor) | |
| | to 5 (very strong bonito flavor)) | |
| Test | Intensity of gluten odor | 1.8 |
| Exam- | (0 (no noticeable gluten odor) | |
| ple 2-2 | to 5 (very strong gluten odor)) | |
| | Intensity of bonito flavor | 0.3 |
| | (0 (no noticeable bonito flavor) | |
| | to 5 (very strong bonito flavor)) | |
| Test | Intensity of gluten odor | 0.8 |
| Exam- | (0 (no noticeable gluten odor) | |
| ple 2-3 | to 5 (very strong gluten odor)) | |
| | Intensity of bonito flavor | 1.3 |
| | (0 (no noticeable bonito flavor) | |
| | to 5 (very strong bonito flavor)) | |
| Test | Intensity of gluten odor | 0.3 |
| Exam- | (0 (no noticeable gluten odor) | |
| ple 2-4 | to 5 (very strong gluten odor)) | |
| | Intensity of bonito flavor | 2.3 |
| | (0 (no noticeable bonito flavor) | |
| | to 5 (very strong bonito flavor)) | |
| Test | Intensity of gluten odor | 0.1 |
| Exam- | (0 (no noticeable gluten odor) | |
| ple 2-5 | to 5 (very strong gluten odor)) | |
| | Intensity of bonito flavor | 3.3 |
| | (0 (no noticeable bonito flavor) | |
| | to 5 (very strong bonito flavor)) | |

As shown in the above results, the gluten odor was suppressed by incorporating the dried-bonito powder into noodles with an available carbohydrate content reduced by 50%. In Test Example 2-2 to Test Example 2-3, the bonito flavor was not noticeable or was slightly noticeable. In Test Example 2-4 to Test Example 2-5, the bonito flavor was noticeable, but was not strong.

1. Noodles comprising wheat flour and further comprising wheat protein,
the proportion of the wheat protein in the total amount of powdered raw materials contained in the noodles being 10 mass % or more,
the noodles having an available carbohydrate content reduced by 25 mass % or more compared with noodles containing only wheat flour as a powdered raw material, and
the noodles comprising a dried-bonito powder in an amount of 0.2 to 10 mass % based on the total amount of the powdered raw materials.

2. The noodles according to claim 1, which have an available carbohydrate content reduced by 50 mass % or more compared with noodles containing only wheat flour as a powdered raw material.

3. The noodles according to claim 1, wherein the proportion of the wheat protein in the total amount of the powdered raw materials constituting the noodles is 15 mass % or more.

4. A masking agent for an unpleasant odor derived from wheat protein caused by low available carbohydrate noodles, the masking agent comprising a dried-bonito powder, the low available carbohydrate noodles comprising wheat flour and wheat protein and having a reduced available carbohydrate content compared with noodles containing only wheat flour as a powdered raw material.

5. The noodles according to claim 1, wherein the noodles are pasta.

6. A method for masking an unpleasant odor derived from wheat protein caused by low available carbohydrate noodles, the method comprising adding a dried-bonito powder to powdered raw materials constituting the low available carbohydrate noodles, the low available carbohydrate noodles comprising wheat flour and wheat protein and having a reduced available carbohydrate content compared with noodles containing only wheat flour as a powdered raw material.

7. The method according to claim 6, wherein the low available carbohydrate noodles have an available carbohydrate content reduced by 25 mass % or more compared with noodles containing only wheat flour as a powdered raw material.

8. The method according to claim 6, wherein the noodles are pasta.

9. The masking agent according to claim 4, wherein the noodles are pasta.
